(19) United States
(12) Patent Application Publication
(10) Pub. No.: US 2009/0050055 A1
(43) Pub. Date: Feb. 26, 2009

(54) Swirl Coating Applicator

(75) Inventor: Steve Tsai, Stamford, CT (US)

Correspondence Address: Tyco Healthcare Group LP, 60 MIDDLETOWN AVENUE, NORTH HAVEN, CT, 06473, US

(73) Assignee: Tyco Healthcare Group LP

(21) Appl. No.: 12/146,989

(22) Filed: Jun. 26, 2008

Related U.S. Application Data
(60) Provisional application No. 60/965,933, filed on Aug. 23, 2007.

(51) Int. Cl. B05C 1/00

(52) U.S. Cl. 118/300

(57) ABSTRACT

An applicator for coating a suture line is disclosed. The applicator includes a coating cavity having an inlet port for entry of the suture line into the coating cavity and an outlet port for exit of the suture line out of the coating cavity. The applicator also includes one or more injection ports configured to supply a coating composition into the coating chamber in a direction substantially tangential to the coating cavity.

### CROSS-REFERENCE TO RELATED APPLICATION

This application claims the benefit of and priority to U.S. Provisional Patent Application No. 60/965,933, filed Aug. 23, 2007, the entire disclosure of which is incorporated by reference herein.

### BACKGROUND

1. Technical Field

The present disclosure relates generally to filament coating systems and methods, more specifically to systems and methods for coating sutures.

2. Background of Related Art

Surgical sutures are primarily used during surgery to stitch together sections of tissue to aid in post-surgical healing. Sutures are often coated with various substances to improve their knot tie-down characteristics. In addition, a coating may increase a suture's surface lubricity which reduces the friction associated with passing of the suture through tissue, thereby reducing tissue trauma. Conventionally, suture coatings have been applied by brushing, wiping, spraying or dipping. Dip coating involves submergence of a suture line into a coating composition contained in a vessel. The coating composition may be injected into the vessel through one or more injection ports.

The application of coatings has also been accomplished using filling heads. This method may involve passing a suture line through a V-shaped notch to obtain a more even coating. Coating composition injected into the notch contacts and coats the suture line. Although the coating system using filling heads may provide more consistent coating for the suture line, the contact time for the coating solution to penetrate into the suture may be less (e.g., less than about 0.1 seconds) than that provided by conventional dip coating mechanisms.

Improved coating systems and methods for coating medical devices, including sutures, remain desirable.

### SUMMARY

According to one aspect of the present disclosure, an applicator for coating a suture line is disclosed. The applicator includes a coating cavity having an inlet port for entry of the suture line into the coating cavity and an outlet port for exit of the suture line out of the coating cavity. The applicator also includes one or more injection ports configured to supply a coating composition into the coating chamber in a direction substantially tangential to the coating cavity.

According to another aspect of the present disclosure, an applicator for coating a suture line is disclosed. The applicator includes a coating cavity having an inlet port for entry of the suture line into the coating cavity and an outlet port for exit of the suture line out of the coating cavity. The applicator also includes one or more injection ports configured to inject a coating composition into the coating chamber in a direction substantially tangential to the coating cavity thereby generating rotational circulation therein and thereby further promoting the uniformity of the coating composition and flow distribution inside the coating cavity for the passing suture line.

According to a further aspect of the present disclosure, an applicator for coating a suture line is disclosed. The applicator includes a coating cavity having an inlet port for entry of the suture line into the coating cavity and an outlet port for exit of the suture line out of the coating cavity. Each of the inlet port and the outlet port includes a seal having an eyelet sized to allow the at least one suture line to pass therethrough with minimal clearance thereby minimizing loss of the coating composition. The applicator also includes two or more injection ports configured to inject a coating composition into the coating chamber in a direction substantially tangential to the coating cavity thereby generating rotational circulation therein and thereby further promoting the uniformity of the coating composition and flow distribution inside the coating cavity for the passing suture line.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a suture coating system according to one embodiment of the present disclosure;

FIG. 2 is a top cross-sectional view of a coating applicator according to the present disclosure; and

FIG. 3 is a side cross-sectional view of the coating applicator of FIG. 2 according to the present disclosure.

### DETAILED DESCRIPTION

Particular embodiments of the present disclosure will be described herein below with reference to the accompanying drawings. In the following description, well-known functions or constructions are not described in detail to avoid obscuring the present disclosure in unnecessary detail.

The present disclosure provides for a swirl coating system. The system includes one or more input winders inputting a suture line into a coating applicator. The coating applicator includes a coating cavity and one or more injection ports for injecting a coating composition in the cavity. The injection ports may be disposed tangentially to the cavity and may be configured to generate rotational circulation therein, thereby swirling the coating composition. Upon coating, the suture line may be dried and thereafter the line guided to winding rolls.

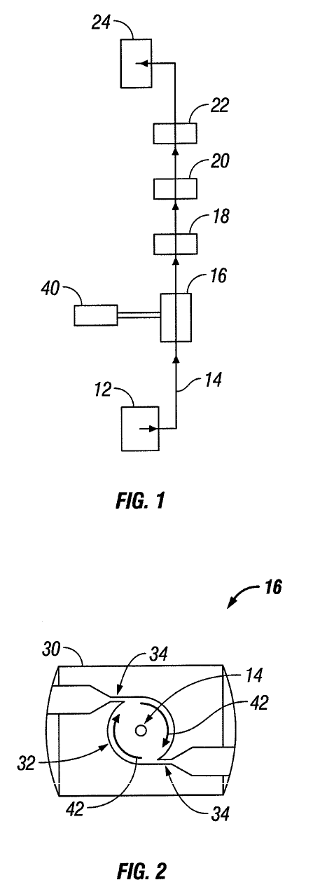

FIG. 1 shows a coating system 10 according to the present disclosure for coating a suture line and/or other filaments (e.g., wire). The coating system 10 includes at least one input winder 12 for passing a suture line 14 through a coating applicator 16, an optional air wiper 18, a dryer 20, an optional air cooler 22 and a take-up winder 24. As the line 14 passes through the coating applicator 16 it is submerged in a coating composition in order to apply the coating composition thereto. The coating is supplied by pump 40. The optional air wiper 18 is disposed between the coating applicator 16 and the dryer 20 and is configured to blow gas (e.g., air, nitrogen, etc.) on the passing line 14 to blow off excess coating composition. The optional air cooler 22 is disposed between the dryer 20 and the take-up winder 24 and may be configured to blow cool air on the line 14 to provide cooling for the dried line. After passing through the coating applicator 16, the line 14 is wound by at least one take-up winder 24.

The input winder(s) 12 disperses the line 14 which may be a monofilament or a multifilament braided suture. Prior to dispersing, the line 14 may be prepared for coating, in embodiments by calendaring the line 14 to facilitate penetration of the coating composition into the interstices of a multifilament braided suture. This may be especially useful where the present system is used to apply a second or third coating composition to the suture line. An example of a suitable calendaring apparatus and method of use thereof is disclosed in commonly owned U.S. Pat. No. 5,312,642 entitled “Method and Apparatus for Calendering and Coating/Filling Sutures” which is incorporated by reference in its entirety herein.

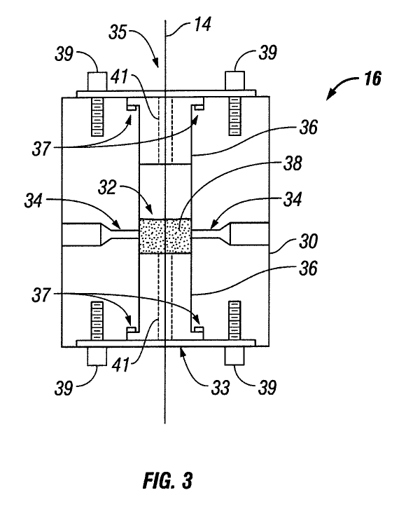

FIGS. 2 and 3 show in more detail the coating applicator 16 in accordance with an embodiment of the present disclosure. The coating applicator 16 includes a housing 30 which may have a tubular or block structure having a coating cavity 32 defined therein. The coating cavity 32 may be formed within the housing traditional milling, casting, and/or drilling techniques and may have a diameter from about 2 mm to about 20 mm, in embodiments from about 3 mm to about 10 mm, and a height from about 5 mm to about 100 mm, in embodiments from about 10 mm to about 50 mm. The housing 30 may be formed from metals, such as stainless steel, titanium, high-alloy cast steel, and the like, ceramics, or plastics, such as polytetrafluoroethylene (PTFE), perfluoroalkoxy fluorocarbon (PFA), polypropylene, polyethylene, polycarbonate, polystyrene, and the like, depending upon material compatibility and corrosion and/or erosion considerations. If metal is used, it may be desirable to passivate the tube to reduce its reactivity. Passivation methods and materials are within the purview of those skilled in the art. Those skilled in the art will also appreciate that the cylindrical shape is merely only one embodiment of the coating cavity 32 and that the cavity may have a variety of shapes (e.g., tubular, rectangular, triangular, pentagonal or hexagonal cross-sectional shapes, etc.).

The housing 30 also includes one or more injection ports 34 which are disposed tangentially with respect to the coating cavity 32. A coating composition 38 is supplied through the injection ports 34 to fill the cavity 32. The coating composition 38 is supplied by a pump 40 (FIG. 1) which is connected to the injection ports 34 via tubing. The pump 40 may be any pump, such as centrifugal, rotary, diaphragm, gear, reciprocating, and the like. Those skilled in the art will appreciate that the tubing used to interconnect the pump 40 and the coating applicator 16 may be manufactured from any materials rigid or flexible as well as chemically inert to a variety of solvents. In one embodiment, the tubing may be made from PTFE or PFA.

The coating composition 38 is pumped into the cavity 32 through the injection ports 34 until the cavity 32 is substantially filled with the coating composition 38. The coating cavity 32 includes an inlet port 33 through which the line 14 enters the cavity 32 and an output port 35 through which the line 14 exits the cavity 32. The inlet and outlet ports 33 and 35 may include an eyelet 36 configured to guide the line 14 therethrough. Each of the eyelets 36 includes a passageway 41 drilled and/or formed therethrough. The passageway 41 has a diameter sized to allow the line 14 to pass therethrough with minimal clearance to eliminate or minimize the loss of the coating composition 38 through the bottom eyelet 36. The diameter of the passageway 41, sometimes referred to herein as the inner diameter of the eyelets 36, may be from about 0.9 mm to about 5 mm, in embodiments from about 1 mm to about 3 mm, depending on the thickness of the line 14. The eyelets 36 may be attached to the housing 30 using one or more bolts 39. Each of the eyelets 36 may also include seal 37 (e.g., an O-ring). The seals 37 may be made from suitable materials, including fluoroelastomers such as those commercially available as VITON® fluoroelastomers (from DuPont), PTFE, fluoroelastomer encapsulated materials, including TEFLON® encapsulated silicone, TEFLON® encapsulated VITON®, TEFLON® encapsulated ethylene propylene diene monomer (EPDM), and other suitable materials.

As shown in FIG. 3, once the cavity 32 is partially filled with the coating composition 38, the line 14 is passed vertically through the coating applicator 16 along the central axis “y” thereof so that the line 14 is in direct contact with the coating composition 38. As stated above, the injection ports 34 are disposed tangentially with respect to the cavity 32 such that injection streams of the coating composition 38 are directed tangentially around the center of the cavity 32, unlike in conventional coating applicators, where the injection port is disposed perpendicular to the suture line so that the injection stream is directly hitting the line. One potential problem with the conventional injection port arrangements is the opposite side of the suture line may be subjected to a different flow distribution which results in roughness of the coating surface and/or dry spots.

The injection streams directed by the injection ports 34 generate rotational circulation as represented by the arrows 42 in FIG. 2. This eliminates uneven flow which is a side effect of pulsation generated by the pumping of the positive displacement pump 40 and/or non-uniform distribution of flow inside the cavity 32 due to perpendicular orientation of the injection port 34. The swirling resulting from the configuration of the present disclosure also results in more uniform coating due to more uniform flow pattern of the coating composition 38 as the coating composition 38 is swirled around the line 14.

The injection ports 34 may have a funnel shape as depicted in FIG. 3 narrowing toward the cavity 32. This configuration is useful for connection to supply tubes but may be useful for increasing flow velocity of the coating composition 38 which, in turn, may provide for increased circulation of the coating composition 38. In embodiments, multiple injection ports 34 may be used depending on the flow rate, solution density and viscosity of the coating composition 38 and whether it is a homogenous solution or dispersion. As seen in FIG. 2, the injection ports 34 may be disposed such that the injection streams 40 are injected in the same direction (e.g., clockwise or counterclockwise) to the circulation of the composition in the cavity and, thus, not cancel each other out.

In FIGS. 2 and 3, the injection ports 34 are disposed on the same horizontal plane with the streams 40 being injected in the clockwise direction. In embodiments, multiple injection ports 34 may be disposed on multiple horizontal planes to provide for circulation along the entire height of the cavity 32.

Any coating composition known to be useful for coating medical devices may be applied to a medical device using the present methods and apparatus. The coating composition can be a solution, dispersion, emulsions or combinations thereof. Suitable coatings may contain, for example, one or more polymeric materials and/or one or more bioactive agents.

In some embodiments, the coating composition includes a polymer, or a combination of polymers. The polymer is most suitably biocompatible, including polymers that are non-toxic, non-inflammatory, chemically inert, and substantially non-immunogenic in the applied amounts. The polymer may be either bioabsorbable or biostable. Bioabsorbable polymers may be gradually absorbed or eliminated by the body by hydrolysis, metabolic process, bulk, or surface erosion. Examples of suitable bioabsorbable materials include, but are not limited to, polyesters, polyorthoesters, polyphosphoesters, poly (amino acids), cyanoacrylates, copoly(ether-esters), polyalkylene oxalates, polyphosphazenes, polyiminocarbonates, aliphatic polycarbonates, combinations thereof, and the like. Specific examples of suitable bioabsorbable materials include, but are not limited to, polycaprolactone (PCL), poly-D, L-lactic acid (DL-PLA), poly-L-lactic acid (L-PLA), lactide, glycolide, poly(lactide-co-glycolide), poly(hydroxybutyrate), poly(hydroxybutyrate-co-valerate), polydioxanone, polyanhydride, poly(glycolic acid), poly(glycolic acid-cotrimethylene carbonate), polyphosphoester urethane, poly(trimethylene carbonate), poly(iminocarbonate), and combinations thereof. Biomolecules such as heparin, fibrin, fibrinogen, cellulose, starch, and collagen may also be suitable for coatings.

A biostable polymer does not break down in the body, and thus a biostable polymer is present in the body for a substantial amount of time after implantation. Examples of biostable polymers include para-xylylene, also known as parylene, and its derivatives including poly-para-xylylene (parylene N), poly-monochloro-para-xylylene (parylene C), poly-dichloro-para-xylylene (parylene D), and fluorinated parylenes (parylene HT) (all of which are commercially available from SPECIALTY COATING SYSTEMS™), polyurethanes (for example, segmented polyurethanes such as BIOSPAN™), polyethylene, polypropylene, polyethlyene teraphthalate, ethylene vinyl acetate, silicone, polyethylene oxide, and polytetrafluoroethylene (PTFE).

In some embodiments, the coating compositions of the present disclosure may also include a fatty acid component that contains a fatty acid or a fatty acid salt or a salt of a fatty acid ester. Suitable fatty acids may be saturated or unsaturated, and include higher fatty acids having more than about 12 carbon atoms. Suitable saturated fatty acids include, for example, stearic acid, palmitic acid, myristic acid and lauric acid. Suitable unsaturated fatty acids include oleic acid, linoleic acid, and linolenic acid. In addition, an ester of fatty acids, such as sorbitan tristearate or hydrogenated castor oil, may be used.

Suitable fatty acid salts include the polyvalent metal ion salts of C6 and higher fatty acids, particularly those having from about 12 to about 22 carbon atoms, and mixtures thereof. Fatty acid salts including the calcium, magnesium, barium, aluminum, and zinc salts of stearic, palmitic and oleic acids may be useful in some embodiments of the present disclosure. Particularly useful salts include commercial “food grade” calcium stearate which consists of a mixture of about one-third C16 and two-thirds C18 fatty acids, with small amounts of the C14 and C22 fatty acids.

Suitable salts of fatty acid esters which may be included in the coating compositions applied in accordance with the present disclosure include calcium, magnesium, aluminum, barium, or zinc stearoyl lactylate; calcium, magnesium, aluminum, barium, or zinc palmityl lactylate; calcium, magnesium, aluminum, barium, or zinc olelyl lactylate; with calcium stearoyl-2-lactylate (such as the calcium stearoyl-2-lactylate commercially available under the tradename VERV from American Ingredients Co., Kansas City, Mo.) being useful in some embodiments. Other fatty acid ester salts which may be utilized include lithium stearoyl lactylate, potassium stearoyl lactylate, rubidium stearoyl lactylate, cesium stearoyl lactylate, francium stearoyl lactylate, sodium palmityl lactylate, lithium palmityl lactylate, potassium palmityl lactylate, rubidium palmityl lactylate, cesium palmityl lactylate, francium palmityl lactylate, sodium olelyl lactylate, lithium olelyl lactylate, potassium olelyl lactylate, rubidium olelyl lactylate, cesium olelyl lactylate, and francium olelyl lactylate.

Where utilized, the amount of fatty acid component can be in an amount from about 5 percent to about 50 percent by weight of the total coating composition, in embodiments from about 10 percent to about 20 percent by weight of the total coating compositions.

In some embodiments, the coating composition contains one or more bioactive agents. The term “bioactive agent”, as used herein, is used in its broadest sense and includes any substance or mixture of substances that have clinical use. Consequently, bioactive agents may or may not have pharmacological activity per se, e.g., a dye. Alternatively a bioactive agent could be any agent which provides a therapeutic or prophylactic effect, a compound that affects or participates in tissue growth, cell growth, cell differentiation, a compound that may be able to invoke a biological action such as an immune response, or could play any other role in one or more biological processes.

Examples of classes of bioactive agents which may be utilized in coatings applied in accordance with the present disclosure include antimicrobials, analgesics, antipyretics, anesthetics, antiepileptics, antihistamines, anti-inflammatories, cardiovascular drugs, diagnostic agents, sympathomimetics, cholinomimetics, antimuscarinics, antispasmodics, hormones, growth factors, muscle relaxants, adrenergic neuron blockers, antineoplastics, immunogenic agents, immunosuppressants, gastrointestinal drugs, diuretics, steroids, lipids, lipopolysaccharides, polysaccharides, and enzymes. It is also intended that combinations of bioactive agents may be used.

Suitable antimicrobial agents which may be included as a bioactive agent in the coating applied in accordance with the present disclosure include triclosan, also known as 2,4,4′-trichloro-2′-hydroxydiphenyl ether, chlorhexidine and its salts, including chlorhexidine acetate, chlorhexidine gluconate, chlorhexidine hydrochloride, and chlorhexidine sulfate, silver and its salts, including silver acetate, silver benzoate, silver carbonate, silver citrate, silver iodate, silver iodide, silver lactate, silver laurate, silver nitrate, silver oxide, silver palmitate, silver protein, and silver sulfadiazine, polymyxin, tetracycline, aminoglycosides, such as tobramycin and gentamicin, rifampicin, bacitracin, neomycin, chloramphenicol, miconazole, quinolones such as oxolinic acid, norfloxacin, nalidixic acid, pefloxacin, enoxacin and ciprofloxacin, penicillins such as oxacillin and pipracil, nonoxynol 9, fusidic acid, cephalosporins, and combinations thereof. In addition, antimicrobial proteins and peptides such as bovine lactoferrin and lactoferricin B may be included as a bioactive agent in the coatings.

Other bioactive agents which may be included as a bioactive agent in the coating composition applied in accordance with the present disclosure include: local anesthetics; non-steroidal antifertility agents; parasympathomimetic agents; psychotherapeutic agents; tranquilizers; decongestants; sedative hypnotics; steroids; sulfonamides; sympathomimetic agents; vaccines; vitamins; antimalarials; anti-migraine agents; anti-parkinson agents such as L-dopa; anti-spasmodics; anticholinergic agents (e.g. oxybutynin); antitussives; bronchodilators; cardiovascular agents such as coronary vasodilators and nitroglycerin; alkaloids; analgesics; narcotics such as codeine, dihydrocodeinone, meperidine, morphine and the like; non-narcotics such as salicylates, aspirin, acetaminophen, d-propoxyphene and the like; opioid receptor antagonists, such as naltrexone and naloxone; anti-cancer agents; anti-convulsants; anti-emetics; antihistamines; anti-inflammatory agents such as hormonal agents, hydrocortisone, prednisolone, prednisone, non-hormonal agents, allopurinol, indomethacin, phenylbutazone and the like; prostaglandins and cytotoxic drugs; estrogens; antibacterials; antibiotics; anti-fungals; anti-virals; anticoagulants; anticonvulsants; antidepressants; antihistamines; and immunological agents.

Other examples of suitable bioactive agents which may be included in the coating composition include viruses and cells, peptides, polypeptides and proteins, analogs, muteins, and active fragments thereof, such as immunoglobulins, antibodies, cytokines (e.g. lymphokines, monokines, chemokines), blood clotting factors, hemopoietic factors, interleukins (IL-2, IL-3, IL-4, IL-6), interferons (β-IFN, (α-IFN and γ-IFN), erythropoietin, nucleases, tumor necrosis factor, colony stimulating factors (e.g., GCSF, GM-CSF, MCSF), insulin, anti-tumor agents and tumor suppressors, blood proteins, gonadotropins (e.g., FSH, LH, CG, etc.), hormones and hormone analogs (e.g., growth hormone), vaccines (e.g., tumoral, bacterial and viral antigens); somatostatin; antigens; blood coagulation factors; growth factors (e.g., nerve growth factor, insulin-like growth factor); protein inhibitors, protein antagonists, and protein agonists; nucleic acids, such as antisense molecules, DNA and RNA; oligonucleotides; and ribozymes.

A single bioactive agent may be utilized to form the coating composition or, in alternate embodiments, any combination of bioactive agents may be utilized to form the coating composition applied in accordance with the present disclosure.

The amounts of coating composition to be applied to a suture may vary depending upon the specific construction of the suture, the size and the material of this construction. In general, the coating composition applied to an unfilled suture may account for from about 0.5 percent by weight to about 4 percent by weight of the coated suture, in embodiments from about 1 percent to about 3 percent by weight of the coated suture. For a filled (i.e., containing a storage stabilizing agent) braided suture, amounts of coating composition may generally vary from about 0.2% to about 3%, in embodiments from about 0.5% to about 2%. As a practical matter and for reasons of economy and general performance, it may be desirable to apply the minimum amount of coating composition consistent with good surface lubricity and/or knot tie-down characteristics, which amount may be readily determined experimentally for any particular suture.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. An applicator for coating at least one suture line comprising:
a coating cavity including at least one inlet port for entry of the at least one suture line into the coating cavity and at least one outlet port for exit of the at least one suture line out of the coating cavity; and
at least one injection port configured to supply a coating composition into the coating chamber in a direction substantially tangential to the coating cavity.

2. An applicator according to claim 1, wherein the coating cavity has a substantially cylindrical shape.

3. An applicator according to claim 2, wherein the coating cavity has a diameter from about 2 mm to about 20 mm.

4. An applicator according to claim 2, wherein the coating cavity has a diameter from about 3 mm to about 10 mm.

5. An applicator according to claim 2, wherein the coating cavity has a height from about 5 mm to about 100 mm.

6. An applicator according to claim 2, wherein the coating cavity has a height from about 10 mm to about 50 mm.

7. An applicator according to claim 1, wherein each of the at least one inlet port and the at least one outlet port includes a seal having an eyelet sized to allow the at least one suture line to pass therethrough with minimal clearance thereby minimizing loss of the coating composition.

8. An applicator according to claim 7, wherein the eyelet has a passageway having a diameter from about 0.9 mm to about 5 mm.

9. An applicator according to claim 1, wherein the housing is formed from a material selected from the group consisting of stainless steel, titanium, high-alloy cast steel, polytetrafluoroethylene, perfluoroalkoxy fluorocarbon, polypropylene, polyethylene, polycarbonate, and polystyrene.

10. An applicator for coating at least one suture line comprising:
a coating cavity including at least one inlet port for entry of the at least one suture line into the coating cavity and at least one outlet port for exit of the at least one suture line out of the coating cavity; and
a plurality of injection ports configured to inject a coating composition into the coating chamber in a direction substantially tangential to the coating cavity thereby generating rotational circulation therein.

11. An applicator according to claim 10, wherein the plurality of injection ports are disposed on a same horizontal plane within the coating cavity.

12. An applicator according to claim 10, wherein the plurality of injection ports are disposed on at least two different horizontal planes.

13. An applicator for coating at least one suture line comprising:
a coating cavity including at least one inlet port for entry of the at least one suture line into the coating cavity and at least one outlet port for exit of the at least one suture line out of the coating cavity, wherein each of the at least one inlet port and the at least one outlet port includes a seal having an eyelet sized to allow the at least one suture line to pass therethrough with minimal clearance thereby minimizing loss of the coating composition; and
a plurality of injection ports configured to inject a coating composition into the coating chamber in a direction substantially tangential to the coating cavity thereby generating rotational circulation therein.

14. An applicator according to claim 13, wherein the coating cavity has a substantially cylindrical shape.

15. An applicator according to claim 14, wherein the coating cavity has a diameter from about 2 mm to about 20 mm.

16. An applicator according to claim 14, wherein the coating cavity has a height from about 5 mm to about 100 mm.

17. An applicator according to claim 13, wherein the eyelet has a passageway having a diameter from about 0.9 mm to about 5 mm.

18. An applicator according to claim 13, wherein the housing is formed from a material selected from the group consisting of stainless steel, titanium, high-alloy cast steel, ceramics, polytetrafluoroethylene, perfluoroalkoxy fluorocarbon, polypropylene, polyethylene, polycarbonate, and polystyrene.

19. An applicator according to claim 13, wherein the plurality of injection ports are disposed on a same horizontal plane within the coating cavity.

20. An applicator according to claim 13, wherein the plurality of injection ports are disposed on at least two different horizontal planes.
